(19) United States
(12) Patent Application Publication
(10) Pub. No.: US 2024/0246186 A1
(43) Pub. Date: Jul. 25, 2024

(54) Protective Cover Having An Installaton Aid

(71) Applicant: ARNO ARNOLD GMBH, Obertshausen (DE)

(72) Inventors: Hagen Schüller, Heusenstamm (DE); Samuel Schaubert, Rodgau-Weiskirchen (DE)

(21) Appl. No.: 18/563,784

(22) PCT Filed: May 13, 2022
(86) PCT No.: PCT/EP22/63017

§ 371 Date: Nov. 22, 2023

(30) Foreign Application Priority Data
May 27, 2021 (DE) 10 2021 113 769.1

(51) Int. Cl. B23Q 11/08

(52) U.S. Cl. CPC B23Q 11/0825; B23Q 11/0816

(57) ABSTRACT

A protective cover having at least one protective-cover element adjustable in length and having at least one frame element, the protective-cover element adjustable in length having at least one holding means, the frame element having a first longitudinal edge, and at least one fastening means being disposed at the first longitudinal edge, and the holding means and the fastening means being connectable in a detachable manner, in particular a force-fitting and/or form-fitting manner. An installation aid is disposed on the fastening means, the installation aid comprising a positioning edge and a guide edge, and the positioning edge and the guide edge essentially being opposite edges at the installation aid.

The present application is a national stage application filed under 35 U.S.C. § 371 of International Application No. PCT /EP2022/063017, filed May 13, 2022, which claims priority to German Patent Application No. 10 2021 113 769.1, filed May 27, 2021. Each of the aforementioned patent applications is incorporated by reference in its entirety for all purposes.

The disclosure relates to a protective cover according to the preamble of claim 1 and to a machine having a corresponding protective cover according to the preamble of claim 16.

From the state of the art, protective covers have been known and serve in particular, though by no means exclusively, for covering movable machine parts or the like. Protective covers of this kind have elements adjustable in length. In this manner, the machine parts are not only protected from outside influences, such as shavings, dust particles or other impurities, when in the retracted and in the extracted state, but are also sealed from the environment. Document DE 20 2012 008 987 U1 is to be mentioned as an example.

These elements of the protective cover are connected to a support frame which serves for stability, in particular support. DE 20 2016 103 836 U1 discloses that the protective-cover element establishes a detachable click connection with the support frame. By means of the detachable click connection, it becomes possible to uninstall parts of the protective frame for maintenance and/or repairs and to subsequently reinstall them.

The click connection known from the state of the art has, however, proven disadvantageous in the respect that the holding and fastening means must be aligned precisely with each other to establish the detachable connection. Otherwise the connection between the fastening means and the holding means is not possible. At the same time, matters are made more difficult by the protective-cover element adjustable in length generally not being transparent. For this reason, the act of aligning holding means and fastening means is often carried out without the holding means and the fastening means being directly visible. Furthermore, it has proven that the click connection bears the disadvantage of becoming detached unintentionally during operation, in particular when protective covers have been in operation for longer periods of time. This occurs because the click connection naturally allows shifting movements of the protective-cover element adjustable in length in relation to the frame element. The shifting movements make a temporary or non-permanent deformation of the protective-cover element adjustable in length and/or of the frame element possible, meaning the click connection unintentionally becomes detached during operation.

Therefore, a large demand exists for a protective cover which ensures a quick, simple, reliable, intuitive and easy exchangeability, maintenance and/or repair of the individual components. At the same time, the components and elements of the protective cover should be securely connected during operation. Moreover, the protective cover should be inexpensive in its production, have a long service life and be individually adaptable to the area of the machine to be protected. The object of the disclosure is therefore to provide a protective cover to overcome the difficulties laid out above and, above all, to reduce the costs caused by maintenance and/or repairs and thus the operational standstills of the machine caused thereby.

This object is attained in a surprisingly simple and effective manner by a protective cover and a machine having a protective cover of this kind according to the teachings of the independent main claims.

According to the disclosure, a protective cover having at least one protective-cover element adjustable in length and having at least one frame element is proposed, the protective-cover element adjustable in length having at least one holding means, the frame element having a first longitudinal edge, and at least one fastening means being disposed at the first longitudinal edge, and the holding means and the fastening means being connectable in a detachable manner, in particular a force-fitting and/or form-fitting manner. The protective cover is characterized in that an installation aid is disposed on the fastening means, the installation aid comprising a positioning edge and a guide edge, and the positioning edge and the guide edge essentially being opposite edges at the installation aid.

The protective cover according to the disclosure is based on the basic idea that the installation aid on the one hand ensures the correct positioning of the protective-cover element adjustable in length at the frame element and subsequently sets and facilitates a correct converging and thus connection of the holding means and the fastening means. In this manner, damage to the holding means and/or to the fastening means are avoided and a wrong installation is precluded. An unintentional detachment due to previous damage resulting from a wrong connection and/or attempts at the like and/or wrongly executed connections as such is therefore not possible. Simultaneously, the required amount of time for uninstalling and/or reinstalling the protective-cover element adjustable in length is shortened, as complicated alignment work is simplified and shortened by a considerably easier act of positioning.

Within the scope of the disclosure, it has been acknowledged that the at least one protective-cover element adjustable in length and the at least one frame element are connected in such a manner for the functionality of the protective cover as intended by the disclosure that a transfer of force and/or movement is possible between these elements. In particular, a force and/or a movement, which leads to the protective-cover element adjustable in length being shortened or lengthened, is intended to be transferred to or from the frame element. If the protective cover has at least two frame elements, it will be obvious to the person skilled in the art that they are to be moved towards each other upon a shortening and away from each other upon a lengthening. A transfer of force and/or movement from one frame element to the next is enabled in this manner via a connection, in particular a force-fitting and/or form-fitting connection, by means of the protective-cover element adjustable in length and via the protective-cover element adjustable in length.

The term “protective cover” refers in particular, though by no means exclusively, to a cover of movable machine parts or the like. In the scope of the disclosure, the term therefore refers to the entire protective cover, an area thereof and/or at least one element thereof. The protective cover according to the disclosure comprises at least one protective cover element adjustable in length in the extraction direction of the protective cover and at least one frame element. The frame element can be part of a support frame, which comprises at least one, preferably several, frame element(s) generally distributed at even distances across the entire length of the protective cover and displaceable in the extraction direction of the protective cover. In this regard, it is advantageous that the frame element has one, at least two, carrier profile(s) for lateral support. Further, the protective cover can comprise a guide, a slide rail, an end frame, an escutcheon and/or a drive. Generic and suitable protective-cover elements are known to the person skilled in the art.

The term “force” refers in particular to an acceleration force and/or a pre-stress force. The acceleration force causes the movement which leads to the shortening or lengthening of the protective-cover element adjustable in length and/or of the at least one frame element. In the scope of the disclosure, the source of the acceleration force is of minor importance in this context. It is conceivable for the acceleration force to be caused by a suitable drive of the protective cover or by a drive of another movable machine part connected to the protective cover. Via the pre-stress force, it becomes possible, on the one hand, to evenly distribute the frame elements and, on the other hand, to twist them. The advantages of such a twist are known to the person skilled in the art. In the scope of the disclosure, the source of the pre-stress force is of minor importance. It is conceivable, however, for the pre-stress force to be partially or entirely mustered by the protective-cover element adjustable in length. The person skilled in the art is familiar with suitable measures and/or embodiments for the protective-cover element adjustable in length.

In addition, it has been acknowledged that a connection of this kind is allowed by a geometric alignment of two components involved in the connection, namely the at least one holding means of the protective-cover element adjustable in length and the at least one fastening means of the frame element. The person skilled in the art is familiar with suitable geometries. This alignment of the geometries allows a simple, quick, stable and durable connection between the protective-cover element and the frame element. According to the disclosure, no additional securing means, such as screws and/or clamps and/or the like, are required for this purpose. In particular, it is possible to detach the connection.

In the scope of the disclosure, it has been further acknowledged that the frame element has at least one first edge. It has been further deemed as essential that the frame element is connectable to the protective-cover element in the area of the first edge. In the scope of the disclosure, it has been further deemed essential that the term “first edge” pertains to any conceivable edge of the frame element and refers to the corresponding edge of the frame element, not, however, to possible holding means, installation aids, guide edges, positioning edges, carrier profiles and/or pre-stress means of the frame element, which can be present in the area of this edge. The positioning of the fastening means in the area of the first edge is based on the notion that the area of the first edge is easily accessible to the user installing or uninstalling the protective cover. For the frame element to be connectable in a detachable manner, in particular in a force-fitting and/or form-fitting manner, to the protective-cover element adjustable in length using the fastening means and to be connectable for transferring movements and/or force, it is further necessary for the protective-cover element to have at least one holding means. Owing to the alignment of the protective-cover element adjustable in length to the frame elements, the position of the holding means on the protective-cover element adjustable in length is arbitrary.

According to the disclosure, the installation aid has a positioning edge to ensure the correct positioning of the protective-cover element adjustable in length and of the frame element in relation to each other. The holding means of the protective-cover element adjustable in length is brought in direct contact with the positioning edge at a first suitable position for this purpose. The positioning edge is suitably designed, meaning this direct contact is only possible in a manner which ensures the correct positioning of the holding means and the fastening means. The precise point of contact of the positioning edge with the first suitable position is arbitrary, making the correct positioning achievable easily and without much effort regarding alignment. Possible suitable embodiments of the positioning edge are described in further detail in the following.

According to the disclosure, the installation aid has a guide edge. The guide edge guides the movement of the frame element and the protective-cover element adjustable in length, after the positioning at the positioning edge has taken place. This movement causes the holding means and the fastening means to be detachably connected to each other. The guiding takes place by moving a second suitable position of the holding means along the guide edge. Possible suitable embodiments of the guide edge are described elsewhere. Preferably, the guide edge first has a consistent curvature, to which an obviously, i.e., evidently, more strongly curved area connects, the guide edge being curved the strongest in the area of the broadest expansion of the guide edge. At this position, the guide edge forms a lug by its direction component parallel to the first edge first falling to 0 and subsequently pointing in the other direction, i.e., in the direction of the fastening means. Preferably, the guide edge inevitably comes into contact with the suitable position of the holding means when the protective-cover element adjustable in length is first moved along the positioning edge towards the frame element after the protective-cover element adjustable in length and the frame element have been positioned using the positioning edge. However, alternatively or additionally, it is also conceivable for the change from the first guiding of the protective-cover element adjustable in length to the guiding along the guide edge to be indicated by optical and/or haptic features on the installation aid. Markings in color, indentations and/or symbols, for example, are conceivable.

The movements of the frame element and/or the fastening means and the protective-cover element adjustable in length and/or the holding means as described above are relative movements. Each movement towards each other can, in this context, be based on a movement of the frame element or of the protective-cover element adjustable in length on their own or on a simultaneous or alternating movement of both elements. Any and all combinations of conceivable movements fall into the scope of the disclosure. For instance, a movement of the protective-cover element adjustable in length along the guide edge also pertains to a movement of the frame element using the guide edge along the protective-cover element adjustable in length and to a relative movement of the elements towards each other.

It is also significant to the disclosure that the positioning edge and the guide edge are opposite edges on the installation aid. In the scope of the disclosure, it has been discovered that the connection between the holding means and the fastening means is detachable and can be configured particularly to counter an unintentional detachment if the direction of the act of the detachment is a movement which is perpendicular to the extraction direction and has at least one change in direction. This is enabled by the change of the positioning edge to the guide edge. This change, however, is only possible when these edges are disposed on essentially opposite sides of the installation aid. It is further conceivable for the installation aid to have further edges on other sides. An upper edge for the upper closure of the installation aid is conceivable, for example, the installation aid being disposed between the positioning edge and the guide edge.

The term “essentially opposite edges” pertains to edges which do not overlap and whose end points differ in at least one point.

The material of which the protective-cover element adjustable in length is made is generally arbitrary, as long as the material meets requirements. Preferably, the protective-cover element adjustable in length is made of a plastic material, a plastic compound and/or a mixture thereof, the plastic material, the plastic compound and/or the mixture thereof being foldable, textile, inherently rigid and/or thermoplastic. It is further preferred that the protective-cover element adjustable in length is made of a rigid, robust web or a light film. Particularly preferably, it is conceivable for the material to be a thermoplastic material, a thermoplastic compound and/or a thermoplastic mixture thereof. Among the preferred thermoplastic materials are the following: acryolonitrile butadiene styrene (ABS), polyamide (PA), polymethyl methacrylate (PMMA), polycarbonate (PC), polyethylene (PE), terephthalate (PT), polypropylene (PP), polystyrene (PS), polyetherketones (PEK), polyvinyl chloride (PVC) and corresponding copolymers and/or mixtures. The person skilled in the art is familiar with these materials, including their advantages and usages.

The material of which the frame element is made is generally arbitrary, as long as the material meets requirements. Preferably, the frame element is made of an inherently rigid polymer material, an inherently rigid polymer connection, a fiber composite, a metal, in particular aluminum, a metal connection, a metal alloy, in particular stainless steel, and/or a mixture thereof. The person skilled in the art is familiar with these materials including their advantages and usages.

The disclosure makes possible providing a protective cover which allows intuitively, easily and quickly uninstalling and exchanging individual components. This significantly reduces standstill times of the machine caused by maintenance and/or repairs and facilitates repairs and maintenance as such. Further, maintenance and/or repair-induced costs are reduced, as individual components can be exchanged, thereby in particular reducing material costs. A time and cost-intensive uninstallation and/or substitution of the entire protective cover can consequently be prevented. Simultaneously, it is possible, by exchanging individual components, to retrofit the protective cover or adapt it to on-site conditions, whereby it becomes universally deployable.

Advantageous embodiments of the disclosure, which can be realized individually or in combination with each other, are presented in the dependent claims.

In an embodiment of the disclosure, it is conceivable for the positioning edge to be straight and formed at an angle ranging from 80° to 100°, preferably at an angle of 80°, 81°, 82°, 83°, 84°, 85°, 86°, 87°, 88°, 89°, 90°, 91°, 92°, 93°, 94°, 95°, 96°, 97°, 98°, 99° or 100° to the first longitudinal edge. Preferably, the positioning edge is perpendicular to the first longitudinal edge at an angle of 90°. In the scope of the disclosure, it has been discovered that the protective-cover element adjustable in length can be positioned easily and quickly with respect to the frame element in particular when the point is arbitrary at which the first suitable position of the holding means at the positioning edge is aligned. This is attained by a straight positioning edge which is formed at the angle between 80° and 90°, as mentioned above. In the scope of the disclosure, it has been acknowledged that this merely leads to the space between the frame element and the protective-cover element adjustable in length to be changed, while the alignment remains unaffected. However, for a first alignment of the frame element with the protective-cover element adjustable in length, this distance is arbitrary. If the enclosed angle is greater than 90°, the distance between the positioning edge and the guide edge towards the fastening means becomes larger. This has the advantage that the user connecting or separating the protective-cover element and the frame element is led to the movement which ultimately establishes or detaches the connection. However, if the angle is smaller than 90°, the space between the positioning edge and the guiding edge towards the fastening means becomes smaller. An embodiment of this kind increases the safety of the connection between the protective-cover element adjustable in length and the frame element. A too large or too small angle, in contrast, significantly encumbers the positioning. In the scope of the disclosure, it has proven that the angle between 80° and 100° as mentioned above allows the simultaneous use of the advantages described above and a safe positioning.

The term “straight” pertains to the property of an edge to extend along the shortest connection of two points. In particular, an edge which does not have a curvature or a corner is straight.

Furthermore, it is conceivable for the positioning edge to be disposed in the middle third of the fastening means. Preferably, the positioning edge is disposed centrally. In the scope of the disclosure, it has been discovered that the position of the positioning edge along the fastening means determines whether and to which extent it is possible for the installation aid to protrude laterally from the fastening means and to form a protrusion. Moreover, it has been discovered that the lateral protrusion of the installation aid and the thus formed protrusion increases the safety with respect to an unintentional detachment of the holding means the fastening means from each other. However, this means on the other hand that the intentional detachment and connection of the holding means and the fastening means requires greater effort. The position of the positioning edge in the middle third poses a good compromise between safety and effort.

It is further conceivable for the guide edge to protrude laterally from the fastening means. The lateral protrusion forms an additional safety to counteract an unintentional detachment of the fastening means and the holding means.

The term “lateral protrusion from the fastening means” means that the installation aid and/or the guide edge extend at least partially in an area of the first longitudinal edge, in which area the fastening means is not disposed, the installation aid and/or the guide edge being spaced apart from the first longitudinal edge.

In another embodiment of the disclosure, it is conceivable for the entirety of or at least sections of the guide edge to be completely straight and/or curved. In the scope of the disclosure, it has been acknowledged that the guide edge sets the movement direction of the frame element and of the protective-cover element adjustable in length towards each other. In this context, the guide edge in particular sets the movement which is required for connecting the holding means and the fastening means. This connection is in particular safe for counteracting an unintentional detachment when the movement has several different direction components. For this purpose, at least one, in particular several, direction component(s) should in particular be available which is/are perpendicular to the extraction direction of the protective cover. Even more preferably, all direction components are perpendicular to the extraction direction of the protective cover. The guide edge can set a change in direction of this kind via a curved design, for example. In this case, the change in the movement direction is flowing. This has the advantage that the protective-cover element adjustable in length cannot be damaged by the installation aid. If, however, an abrupt change in the movement direction is to be set by the guide edge, the guide edge has two sections which abut against each other and which can be straight. In this context, the straight sections enclose an angle which is not 180°. Preferably, it is less than 180°. A design of this kind leads to the user installing or uninstalling the protective cover to pause. In this context, additional or other steps can be carried out, for example. An example is elucidated elsewhere in this specification.

The term “curved” means a local, gradually occurring deviation of the guide line from a straight line.

It is further conceivable for the installation aid to comprise one clamping edge between the guide edge and the fastening means. The clamping edge serves to clamp the protective-cover element adjustable in length. Preferably, the protective-cover element adjustable in length is clamped between the clamping edge and the first longitudinal edge of the frame element. It has been discovered in the scope of the disclosure that the protective-cover element is guided along the guide edge to its final position in which the fastening means and the holding means are connected to each other. It has been further acknowledged in the scope of the disclosure that a movement of the holding means and the fastening means in relation to one another is to be avoided as much as possible in this state. This movement can cause an unintentional detachment and/or damage to the frame element and/or to the protective-cover element adjustable in length. An additional clamping and thus establishing of another form-fitting and/or force-fitting connection of the protective-cover element adjustable in length reduces movements of this kind and thus increases the safety with respect to an unintentional detachment and/or damage. At the same time, the play between the fastening means and the holding means is reduced, meaning an efficient transfer of force and/or movement is possible. In this manner, a more efficient and steady displacement of the protective cover is made possible.

In another embodiment, it is conceivable for the clamping edge to be parallel to the first longitudinal edge and to be spaced apart from the first longitudinal edge via a clamping-edge space, the clamping-edge space being smaller than or equal to the material thickness of the protective-cover element adjustable in length. In the scope of the disclosure, it has been discovered that an object is clamped in particular when it is placed in a space which is smaller than or equal to its own measurements. In this context, it is obvious to the person skilled in the art that the space has to be smaller than the object to be clamped in particular when the object to be clamped is pliable. In this context, the following applies: the more pliable the material of the protective-cover element adjustable in length, the smaller the clamping edge space has to be in comparison to the material thickness. Preferably, the clamping edge space is maximally 99.5%, maximally 99%, maximally 98%, maximally 97%, maximally 96%, maximally 95%, maximally 90%, maximally 85%, maximally 80%, maximally 75%, maximally 70% or less than the material thickness. Typical material thicknesses of the protective-cover element adjustable in length are known to the person skilled in the art. Preferably, the material thickness is 0.1 mm to 1 mm.

It is conceivable for at least one pre-stress means to be disposed at the first longitudinal edge. In the scope of the disclosure, it has been discovered that a pre-stress force adequate for the requirements is required to achieve the required sealing of the movable machine parts with respect to the environment. Furthermore, the pre-stress force significantly contributes to the stability of the protective cover as stipulated by requirements and regulations. In the scope of the disclosure, it has been acknowledged that the fastening means having the installation aid and the holding means on their own do not generate the pre-stress force as required for all usage possibilities depending on their position. The position of a pre-stress means on the first longitudinal edge, in conjunction with the fastening means and the installation aid, allows increasing the pre-stress force to the level required.

Preferably, the holding means and the fastening means are designed such that the fastening means is guided from a first side of the protective-cover element adjustable in length to a second side of the protective-cover element adjustable in length via the holding means upon a connection of the fastening means and the holding means as intended by the disclosure. The pre-stress means, in contrast, abuts against the first side of the protective-cover element adjustable in length. As the fastening means having the installation aid and the pre-stress means are located on the same plane, the protective-cover element adjustable in length is clamped therebetween. Via a suitable design of the protective-cover element, this clamping generates a pre-stress force which is transferred to the frame element.

In a preferred embodiment, it is conceivable for the pre-stress means to have a pre-stress-means height, the fastening means to have a fastening-means height and the installation aid to have an installation-aid height, the pre-stress-means height being greater than the fastening-means height and/or the pre-stress-means height being smaller than the sum of the fastening means height and the installation-aid height.

Visually shown, the following preferably applies:

$${h}_{B M} < {h}_{V M} < {h}_{B M} + {h}_{M H}$$

h_{BM}: fastening-means height
h_{VM}: pre-stress-means height
h_{MH}: installation-aid height
wherein it is preferable for one or both conditions to be met.

In the scope of the disclosure, it has been discovered to be advantageous for the reliable function of the installation aid if the first contact of the frame element with the protective-cover element adjustable in length to be carried out at the installation aid in the area of the positioning edge and not in the area of the pre-stress means. This is ensured by the sum of the installation-aid height and the fastening-means height being greater than the pre-stress-means height. In addition, it is easier for the user installing or uninstalling the protective cover to establish the pre-stress force by means of the pre-stress means when this step occurs, prior to having established the detachable connection between the fastening means and the holding means. This is allowed by the pre-stress-means height being greater than the fastening-means height. In this manner, the protective-cover element adjustable in length first comes into contact with the pre-stress means and only then comes into contact with the fastening means. Preferably, the user installing or uninstalling the protective cover is induced to pause shortly before the step of mustering the pre-stress force via the pre-stress means owing to a suitable design of the guide edge as described elsewhere. Preferably, the fastening-means height is 1 mm to 6 mm, preferably 1.25 mm, 1.5 mm, 1.75 mm, 2 mm, 2.25 mm, 2.5 mm, 3 mm, 3.25 mm, 3.5 mm, 3.75 mm, 4 mm, 4.25 mm, 4.5 mm, 4.75 mm, 5 mm, 5.25 mm, 5.5 mm, 5.75 mm, or 6 mm; the installation-aid height is 5 mm to 20 mm, preferably at least 6 mm, at least 6.5 mm, at least 7 mm, at least 7.5 mm, at least 8 mm, at least 8.5 mm, at least 9 mm, at least 9.5 mm, at least 10 mm, at least 10.5 mm, at least 11 mm, at least 11.5 mm, at least 12 mm, at least 12.5 mm, at least 13 mm, at least 13.5 mm, at least 14 mm, at least 14.5 mm, at least 15 mm, at least 15.5 mm, at least 16 mm, at least 16.5 mm, at least 17 mm, at least 17.5 mm, at least 18 mm, at least 18.5 mm, at least 19 mm or at least 19.5 mm; and the pre-stress-means height is 3 mm to 15 mm, preferably 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, or 15 mm. Particularly preferably, the fastening-means height is 3 mm, the installation-aid height is 8.6 mm, and the pre-stress-means height is 6 mm. With these measurements, the pre-stress-means height is greater than the fastening-means height, and the pre-stress-means height is smaller than the sum of the fastening-means height and the installation-aid height:

$${h}_{B M} = 3 mm < {h}_{VM} = 6 mm$$

$$and$$

$${h}_{VM} = 6 mm < {h}_{B M} + {h}_{M H} = 3 mm + 8.6 mm = 11.6 mm$$

The terms “fastening-means height”, “installation-aid height” and “pre-stress-means height” pertain to the corresponding extension of the corresponding means or aids in the vertical direction to the first longitudinal edge. The extension of the fastening means and the pre-stress means begins directly at the first longitudinal edge. The extension of the installation aid begins at the upper edge of the fastening means. This edge can also be seen as an imagined line.

In another embodiment, it is conceivable for 1, 2, 3, 4, 5, 6, 7, 8, 9, 10, 11, 12, 13, 14, 15, 16, 17, 18, 19, 20 or more of the same or different fastening means and 1, 2, 3, 4, 5, 6, 7, 8, 9, 10 or more of the same or different pre-stress means to be disposed at the first longitudinal edge, the fastening means and the pre-stress means being disposed in regular or irregular, in particular alternating, sequences. It is generally arbitrary which sequence the fastening means and the pre-stress means follow. However, the pre-stress force can be increased in a targeted manner from this positioning in certain areas via the positioning of several pre-stress means or can be reduced in a targeted manner by omitting pre-stress means. In this manner, the pre-stress force can be adapted to the circumstances as required. It is obvious to the person skilled in the art that the number of fastening means and the number of pre-stress means must be equal or can maximally deviate by one for the alternating arrangement. Preferably, the first longitudinal edge has three fastening means and two pre-stress means, which are disposed alternatingly starting with the fastening means.

In yet another embodiment of the disclosure, it is conceivable for the fastening means to have a fastening-means breadth and the installation aid to have an installation-aid breadth, the value of the installation-aid breadth deviating less than 10% from the value of the fastening-means breadth. In the scope of the disclosure, it has been discovered that the fastening means has a fastening-means breadth and the holding means has a holding-means breadth. Via the intended force-fitting and/or form-fitting connection between fastening means and holding means, it is necessary to coordinate the fastening-means breadth and the holding-means breadth. According to the disclosure, the holding means is guided via the installation aid. For this purpose, it is necessary for the installation-aid breadth to be the same or less than the fastening-means breadth. Otherwise, the holding means cannot be guided via the installation aid. If, however, the installation aid is too small, it is not obvious to the user installing or uninstalling the protective cover that it is intended to guide the protective-cover element adjustable in length along the guide edge together with holding means, after the broadest location of the installation aid has been passed. For this reason, it has proven the most optimal when the value of the installation-aid breadth deviates less than 10%, preferably less than 9.5%, 9%, 8.5%, 8%, 7.5%, 7%, 6.5%, 6%, 5.5% or 5%, from the value of the fastening-means breadth.

The terms “fastening-means breadth”, “installation-aid breadth” and “holding-means breadth” each pertain to the spatial expansion parallel to the clamping edge. With regard to the holding-means breadth, the preceding definition refers to the installed state. Unaffected by this, the holding means has a holding-means breadth in the uninstalled state.

Furthermore, it is conceivable for the protective-cover element adjustable in length to be a pleated element, the at least one holding means being disposed on a pleat or on a pleat flank.

Furthermore, it is conceivable for a blocker to be comprised which limits the maximum length in the extraction direction of the pleated element and is designed as a pleated element in the sense of the disclosure. Generally, it is arbitrary in which manner the protective-cover element adjustable in length and/or the blocker is/are designed; however, the use of pleated elements in protective covers is widely known in the state of the art.

The term “pleated element” pertains to a protective-cover element adjustable in length in which pleats are formed. The pleats enclose an angle, and the change of the length of the protective-cover element adjustable in length is entirely or significantly caused by the change of this angle. In particular, the pleated element has pleats, which alternately are directed towards the machine and away from the machine. It is also conceivable, however, for the pleated element to have pleats only directed towards the machine or away from the machine. Equally, it is conceivable for the pleated element to have an arbitrary number of pleats which are directed towards the machine or away from the machine and are disposed in regular or irregular sequences. In this context, the holding means can be disposed in a pleat directed towards the machine or away from the machine.

The term “pleat flank” pertains to the area of the pleated element which is enclosed by two adjacent pleats or between a pleat and an edge. The pleat flank can be straight or curved.

In one embodiment, it is conceivable for the pleat flank to have at least one kink. If the pleat flank has a kink, it becomes easier for the user installing or uninstalling the protective cover to connect the pleated element to the support frame. In particular, clamping the pleated element between the installation aid and the pre-stress means is facilitated if the support frame contains a pre-stress means. At the same time, the pleated element is alleviated at this position, meaning the pre-stress means does not continuously grate against the pleated element.

The term “kink” pertains to a sudden change of direction of the pleated element, this change not or only slightly contributing to the change in length of the adjustable protective-cover element in the vicinity to the pleat.

In another embodiment, it is conceivable for the frame element to comprise a cover leg. Preferably, the cover leg engages behind the cover leg of an adjacent frame element to form a closed front. Alternatively, the cover leg can also engage behind a part of the machine or a different part of the frame in order to form a closed front. The closed front formed in this manner is closed independently of the current length of the protective cover. The person skilled in the art is familiar with the fact that the closed front is itself adjustable in length via the telescopic-like rear engagement. For this purpose, the cover leg is preferably fastened at the frame element at a second longitudinal edge opposite the first longitudinal edge. Even more preferably, it is fastened at an angle ranging from 80° to 100°, preferably at an angle of 80°, 81°, 82°, 83°, 84°, 85°, 86°, 87°, 88°, 89°, 90°, 91°, 92°, 93°, 94°, 95°, 96°, 97°, 98°, 99° or 100°. Preferably, the cover leg is made of an inherently rigid plastic material, an inherently rigid plastic compound, a fiber composite, a metal, in particular aluminum, a metal connection, a metal alloy, in particular a stainless steel or a high-grade stainless steel, and/or a mixture thereof. More preferably, the cover leg is formed such that it has a wiping effect, in particular a strong wiping effect. This bears the advantage that the protective cover is not only liquid-proof and dust-proof, but also wards off impurities, such as hot and/or sharp shavings. This leads to the machine and/or its movable parts to be reliably protected from even strong impurities.

In one embodiment of the disclosure, it is conceivable for the at least one frame element and the cover leg to be made in one, two or multiple pieces, these elements being connected in a non-permanent manner, e.g., via adhesion, sutures and/or bolts, or in a permanent manner, e.g., via welding, in the case of a two or multi-piece design. In the scope of the disclosure, the type of connection is of minor importance.

It is presumed that the definitions and details of the terms mentioned above apply to all aspects described in the following description, provided it has not been stated otherwise.

According to the disclosure, a machine comprising the protective cover according to the disclosure is further proposed.

The term “machine” is known to the person skilled in the art and pertains to a machine to be protected, such as a machine tool.

Further details, features and advantages of the disclosure are derived from the following description of the preferred exemplary embodiments in conjunction with the dependent claims. In this context, the corresponding features can be realized on their own or several in combination with each other. The disclosure is not limited to the exemplary embodiments. The exemplary embodiments are shown schematically in the figures. The same reference numerals in the individual figures describe elements which are the same or the same in function or correspond to each other regarding their function.

As presented in detail

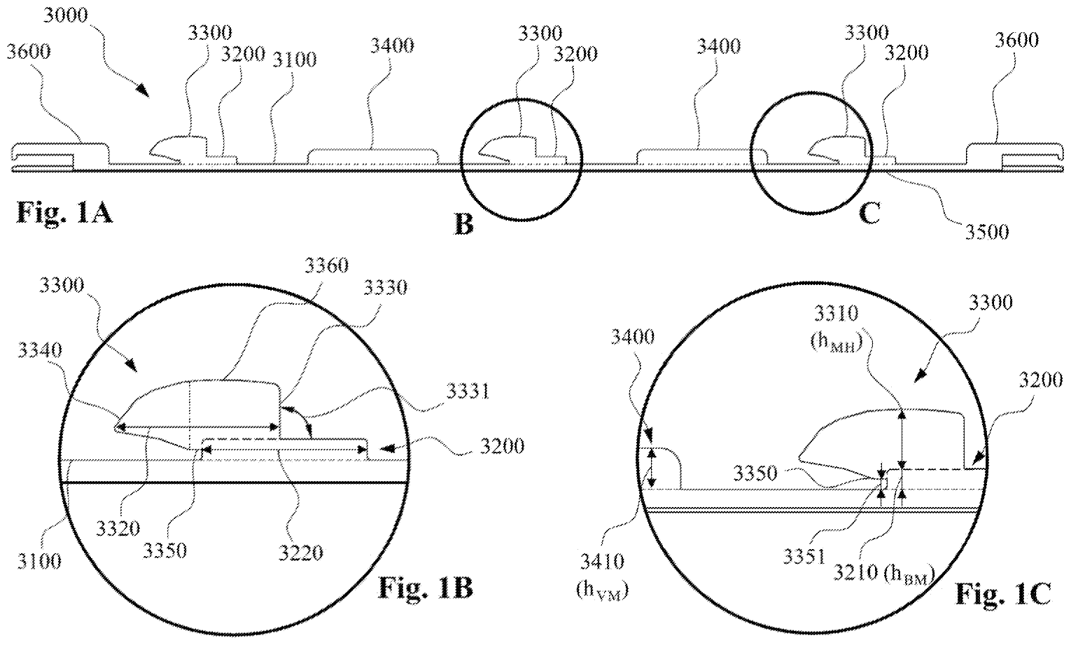

FIG. 1A shows a front top view of a frame element:

FIG. 1B shows a detailed front top view of a fastening means having an installation aid;

FIG. 1C shows a detailed front top view of a section of the front side of a fastening means having an installation aid and a pre-stress means:

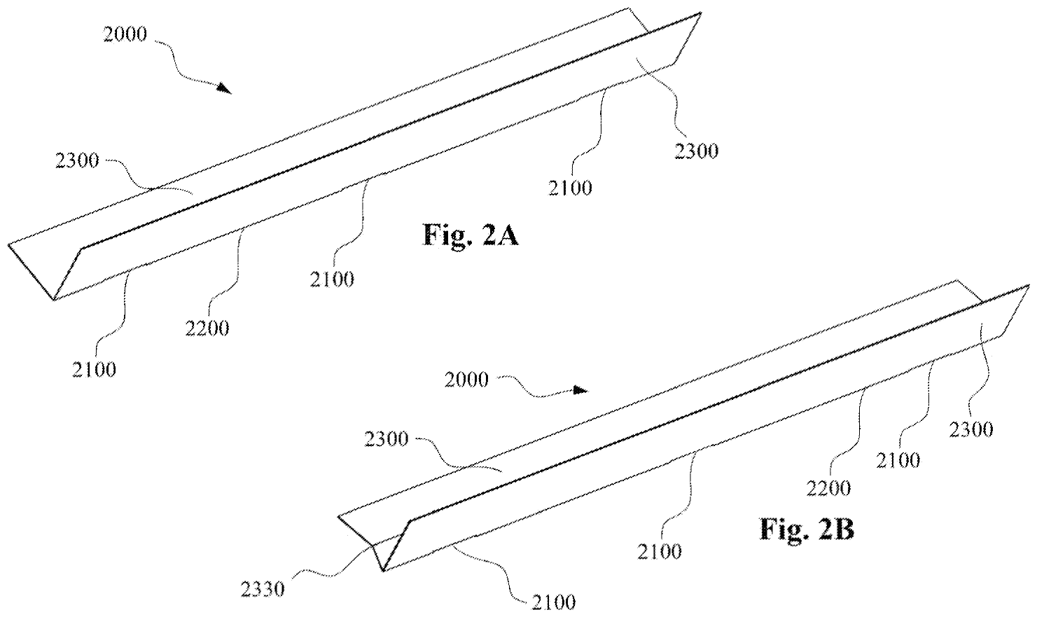

FIGS. 2A and 2B show an isometric view of a first and a second embodiment of a protective-cover element adjustable in length:

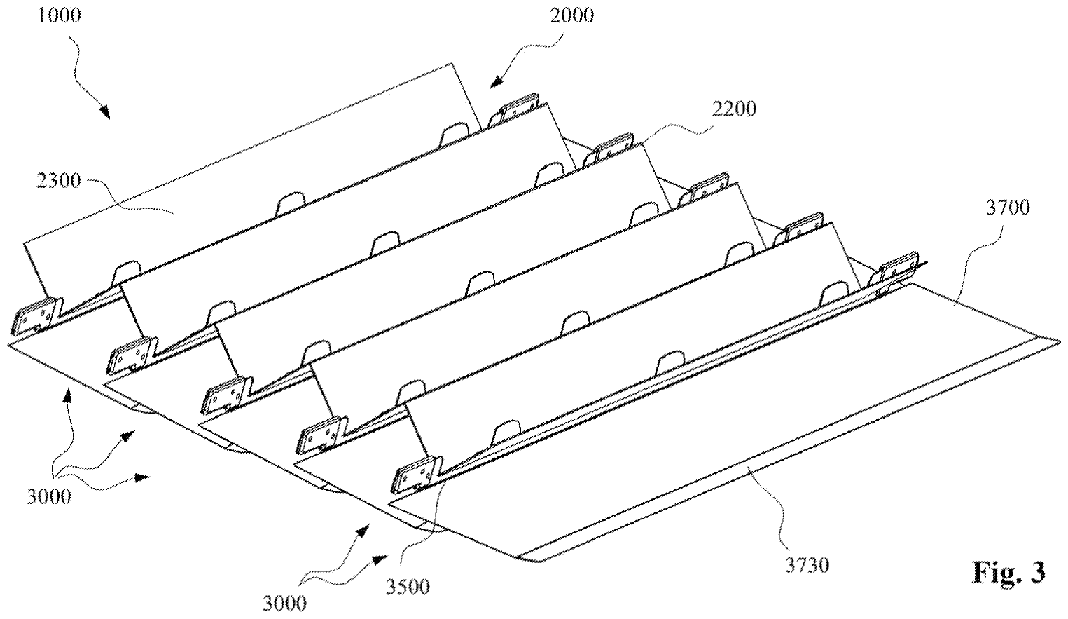

FIG. 3 shows an isometric view of a protective cover: and

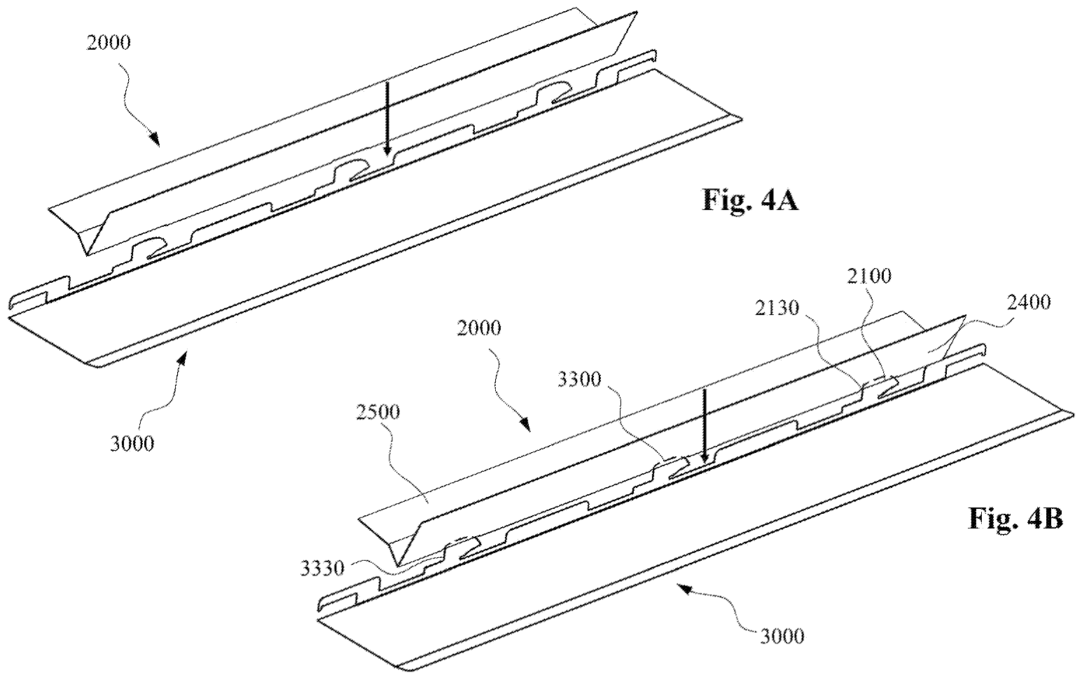

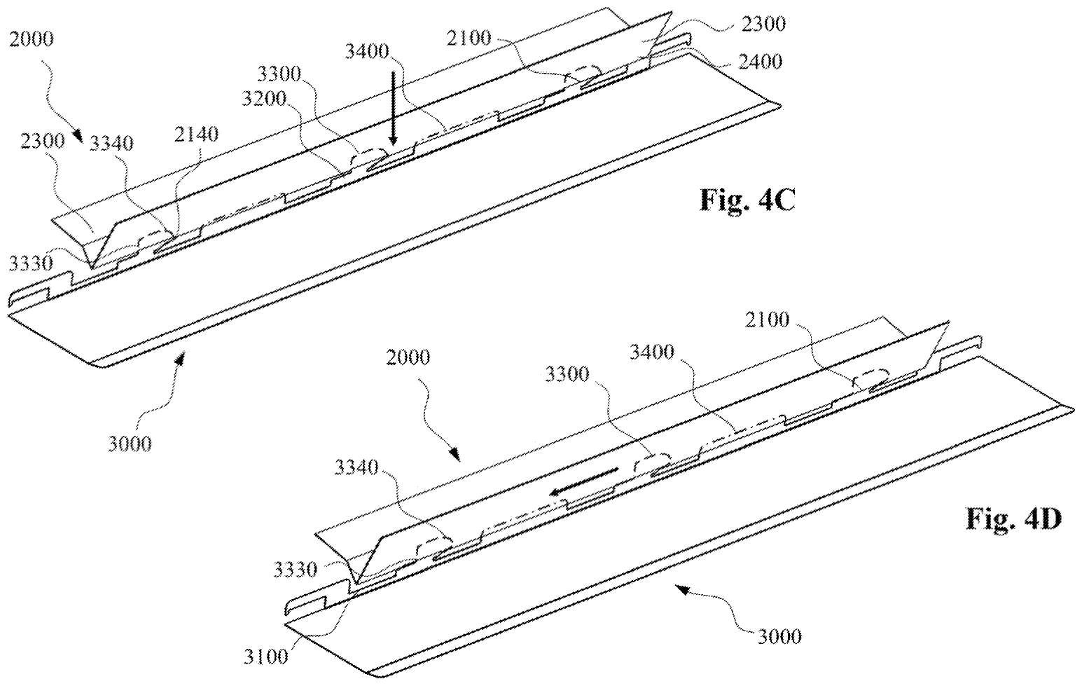

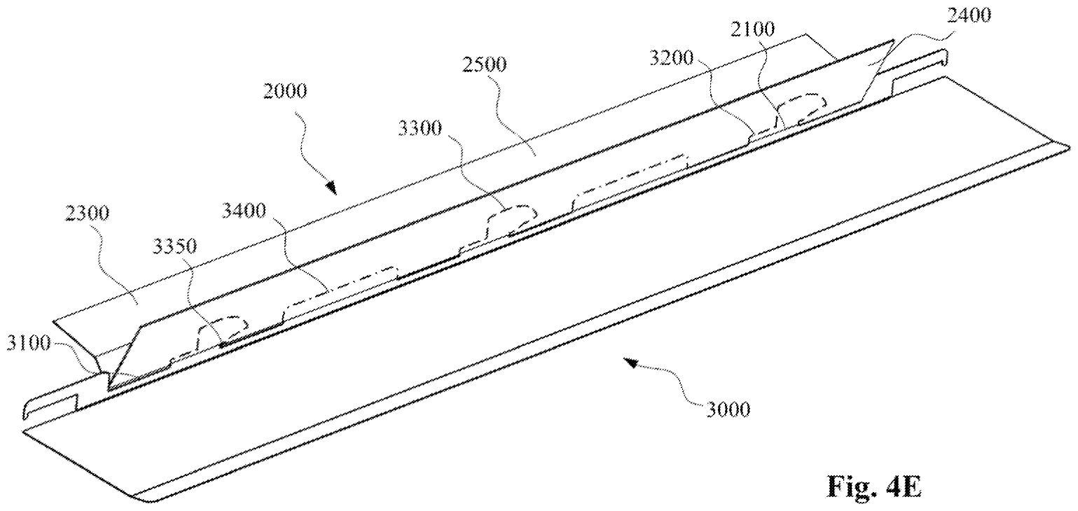

FIG. 4A to FIG. 4E show an isometric view of a movement sequence for connecting a protective-cover element adjustable in length and a frame element.

FIG. 1A shows a front top view of a frame element 3000. Frame element 3000 has a first longitudinal edge 3100 and, opposite first longitudinal edge 3100, a second longitudinal edge 3500. Frame element 3000 has a carrier profile 3600 on each side. By means of both carrier profiles 3600, frame element 3000 is laterally supported. In this exemplary embodiment, three fastening means 3200 are disposed at first longitudinal edge 3100. At each fastening means 3200, an installation aid 3300 is disposed. Moreover, two pre-stress means 3400 are disposed on first longitudinal edge 3100. Fastening means 3200 and pre-stress means 3400 are alternatingly disposed.

FIG. 1B is an enlargement of section B of FIG. 1A referenced with a B. FIG. 1B therefore shows the front top view on fastening means 3200 having installation aid 3300, which is located in section B. Fastening means 3200 has been completed with a dashed line to show the boundary to installation aid 3300. Fastening means 3200 has a fastening-means breadth 3220. This fastening-means breadth corresponds to the spatial expansion of fastening means 3200 parallel to first longitudinal edge 3100. Installation aid 3300 has an installation-aid breadth 3320. Installation aid 3300 comprises a positioning edge 3330. In this exemplary embodiment, positioning edge 3330 is disposed centrally at fastening means 3200. Positioning edge 3330 encloses an angle 3331 with fastening means 3200. In this exemplary embodiment, angle 3331 is 90°, and positioning edge 3330 is straight. Furthermore, installation aid 3300 comprises a guide edge 3340. Between guide edge 3340 and positioning edge 3330, an upper edge 3360 is disposed. Starting at upper edge 3360, guide edge 3340 has an initially consistent curvature. Subsequently, guide edge 3340 begins to curve more prominently, with the strongest curvature in the area of the broadest extension. At this position, guide edge 3340 forms a lug and subsequently extends towards fastening means 3200. In this area, guide edge 3340 is straight, although it is formed in two sections having slightly different directions. When they converge, these two sections form a corner. Between fastening means 3200 and guide edge 3340, a clamping edge 3350 is disposed. To optically separate upper edge 3360, guide edge 3340 and clamping edge 3350, a dashed line has also been included.

FIG. 1C is an enlargement of section C of FIG. 1A referenced with a C. FIG. 1C therefore shows the front top view on installation aid 3300, and details of the section of fastening means 3200 and pre-stress means 3400, which are located in section B. Installation aid 3300 has an installation-aid height 3310, which is referred to as h_{MH} elsewhere. Fastening means 3200 has a fastening-means height 3210, which is referred to as h_{BM} elsewhere. Pre-stress means 3400 has a pre-stress-means height 3410, which is referred to as h_{VM} elsewhere. As is easily recognizable, pre-stress-means height 3410 is greater than fastening-means height 3210. Furthermore, it can be seen that the sum of fastening-means height 3210 and installation-aid height 3310 is greater than pre-stress-means height 3410. Clamping edge 3350 has a clamping-edge space 3351.

FIGS. 2A and 2B show an isometric view of a first and a second embodiment of a protective-cover element 2000 adjustable in length. In the first embodiment shown in FIG. 2A, protective-cover element 2000 adjustable in length has a pleat 2200. In this pleat 2200, three holding means 2100 are disposed. Holding means 2100 are designed as oblong slots. Moreover, protective-cover element 2000 adjustable in length has two pleat flanks 2300 which each extend between pleat 2200 and an edge of protective-cover element 2000. The second embodiment shown in FIG. 2B of protective-cover element 2000 also has a pleat 2200 having three holding means 2100 disposed thereon. Equally, protective-cover element 2000 adjustable in length has two pleat flanks 2300 which extend between pleat 2200 and two edges of the protective-cover element adjustable in length. One of two pleat flanks 2300 has a kink 2330.

FIG. 3 shows an isometric view of a protective cover 1000. Protective cover 1000 comprises a protective-cover element 2000 adjustable in length and five frame elements 3000. Each frame element 3000 comprises a cover leg 3700. Cover leg 3700 is disposed at a second longitudinal edge 3500. At the opposite edge, cover leg 3700 has a chamfer 3730. Four of five cover legs 3700 each engage behind adjacent frame element 3000 with their chamfers 3730 in the area of their cover leg 3700 and in this manner form a closed front. Chamfer 3730 provides the advantage of a pressing force being exerted so that cover legs 3700 have an at least partial and/or short-term absolute or increased seal of the closed front even in the extracted state and thus have the advantages describe above. Frame elements 3000 are connected to protective-cover element 2000 adjustable in length via the holding means (not shown) and fastening means (not shown) for transferring force and movement. Protective-cover element 2000 adjustable in length comprises nine pleats 2200 and ten flanks 2300 in the shown embodiment.

FIGS. 4A to 4E show an isometric view of a movement sequence for connecting a protective-cover element 2000 adjustable in length and a frame element 3000. FIG. 4A shows protective-cover element 2000 adjustable in length and frame element 3000 in the spatially separate state. Protective-cover element 2000 adjustable in length 2000 and frame element 3000 are already roughly directed towards each other. In order to establish the connection according to the disclosure, protective-cover element 2000 adjustable in length is first moved towards first frame element 3000, as indicated by the arrow in FIG. 4A. In FIG. 4B, protective-cover element 2000 and frame element 3000 are already contacted. In this embodiment, the shown frame element has three fastening means having installation aids 3300, each having a positioning edge 3330, and protective-cover element 2000 adjustable in length has three holding means 2100. A first suitable position 2130 of holding means 2100 has been contacted with one of positioning edges 3330 of installation aid 3300 in each case. Owing to this, the correct alignment of protective-cover element 2000 adjustable in length in relation to frame element 3000 has been ensured, whereby complicated positioning work is no longer required. A part of installation aid 3300 has been guided from a first side 2400 of protective-cover element 2000 adjustable in length to a second side 2500 of protective-cover element 2000 adjustable in length via holding means 2100. Installation aid 3300 is covered by protective-cover element 2000 adjustable in length in this part, which has been indicated by the dashed line. Subsequently, protective-cover element 2000 adjustable in length is guided at first suitable position 2130 along positioning edges 3330 further towards frame element 3000, as indicated by the arrow in FIG. 4B. The movement of protective-cover element 2000 adjustable in length towards frame element 3000 is continued until a second suitable position 2140 of each of the three holding means 2100 comes into contact with a guide edge 3340 of the three installation aids 3300 in each case, as shown in FIG. 4C. Until this point of the movement, two pre-stress means 3400, which are disposed on frame element 3000, have already come into contact with protective-cover element 2000 adjustable in length. Pre-stress means 3400 is clamped behind protective-cover element 2000 adjustable in length and remains on first side 2400. Consequently, it is on a different side of protective-cover element 2000 adjustable in length than fastening means 3200. Protective-cover element 2000 adjustable in length has two pleat flanks 2300 in this embodiment. From the observer's point of view, two pre-stress means 3400 are located behind both pleat flanks 2300, which is indicated by a chain dotted line. After each guide edge 3340 of installation aid 3300 has come into contact with one of the holding means 2100 at second suitable position 2140, second suitable positions 2140 and thus protective-cover element 2000 adjustable in length are guided along guide edge 3340 in the further course of the process. By guiding guide edge 3340, protective-cover element 2000 slides along first longitudinal edge 3100 in a parallel main direction, as indicated with the arrow in FIG. 4D. The guiding along guide edge 3340 continues until the connection between fastening means 3200 and holding means 2100 has been established, as shown in FIG. 4E. For additional safety, protective-cover element 2000 adjustable in length is clamped between three clamping edges 3350, which are disposed at installation aid 3300, and first longitudinal edge 3100. In this manner, an unintentional detachment of protective-cover element 2000 and frame element 3000 is prevented. At rear pleat flank 2300, as viewed by the observer, both pre-stress means 3400 continue to abut against first side 2400, while the three fastening means 3200 abut against second side 2500. This allows rear pleat flank 2300, as viewed by the observer, to be clamped between pre-stress means 3400 and fastening means 3200, which allows transferring the pre-stress force from protective-cover element 2000 adjustable in length to frame element 3000.

1. A protective cover having at least one protective-cover element adjustable in length and having at least one frame element, the protective-cover element adjustable in length having at least one holding means, the frame element having a first longitudinal edge, and at least one fastening means being disposed at the first longitudinal edge, and the holding means and the fastening means being connectable in a detachable manner, in particular a force-fitting and/or form-fitting manner,
wherein
an installation aid is disposed at the fastening means, the installation aid comprising a positioning edge and a guide edge, and the positioning edge and the guide edge essentially being opposite edges at the installation aid.

2. The protective cover according to claim 1, wherein the positioning edge is straight and formed at an angle of 80° to 100° to the first longitudinal edge.

3. The protective cover according to claim 1, wherein the positioning edge is disposed in the middle third of the fastening means.

4. The protective cover according to claim 1, wherein the guide edge protrudes laterally from the fastening means.

5. The protective cover according to claim 1, wherein the entirety or at least sections of the guide edge are straight and/or curved.

6. The protective cover according to claim 1, wherein the installation aid comprises a clamping edge between the guide edge and the fastening means.

7. The protective cover according to claim 6, wherein the clamping edge is parallel to the first longitudinal edge and is spaced apart from the first longitudinal edge via a clamping-edge space, the clamping-edge space being smaller than or equal to the material thickness of the protective-cover element adjustable in length.

8. The protective cover according to claim 1, wherein at least one pre-stress means is disposed at the first longitudinal edge.

9. The protective cover according to claim 8, wherein the pre-stress means has a pre-stress-means height, the fastening means has a fastening-means height and the installation aid has an installation-aid height, and the pre-stress-means height being greater than the fastening-means height and/or the pre-stress-means height being smaller than the sum of the fastening means height and the installation-aid height.

10. The protective cover according to claim 8, wherein one to twenty fastening means and one to ten pre-stress means are disposed at the first longitudinal edge, the fastening means and the pre-stress means being disposed in a regular or irregular, in particular alternating, sequence.

11. The protective cover according to claim 1, wherein the fastening means has a fastening-means breadth and the installation aid has an installation-aid breadth, the value of the installation-aid breadth deviating less than 10% from the value of the fastening-means breadth.

12. The protective cover according to claim 1, wherein the protective-cover element adjustable in length is a pleated element, the holding means being disposed on a pleat or on a pleat flank.

13. The protective cover according to claim 12, wherein the pleat flank has a kink.

14. The protective cover according to claim 1, wherein the frame element comprises a cover leg.

15. The protective cover according to claim 14, wherein the frame element having the cover leg is made in one, two or multiple pieces.

16. A machine comprising the protective cover according to claim 1.
